(19) United States
(12) Patent Application Publication
(10) Pub. No.: US 2016/0296903 A1
(43) Pub. Date: Oct. 13, 2016

(54) Emulsifiers from olive solid waste

(71) Applicants: Christos Ritzoulis, (US); Andreas Filotheou, (US)

(72) Inventors: Christos Ritzoulis, Thessaloniki (GR); Andreas Filotheou, Thessaloniki (GR)

(21) Appl. No.: 14/680,110

(22) Filed: Apr. 7, 2015

(51) Int. Cl. B01F 17/00

(52) U.S. Cl. CPC B01F 17/00; B01F 17/0092; B01F 17/0028; B01F 17/005

(57) ABSTRACT

A process is described by which the solid waste of olive processing remaining after oil expression and husk oil extraction is dehydrated, treated with alcoholic solutions, the alcohol being removed, the solid residue subjected to aqueous extractions, the aqueous medium being separated from the remaining solids and concentrated. The said material is also described, being capable of emulsifying oil-in-water emulsions and provide stability to colloidal foods.

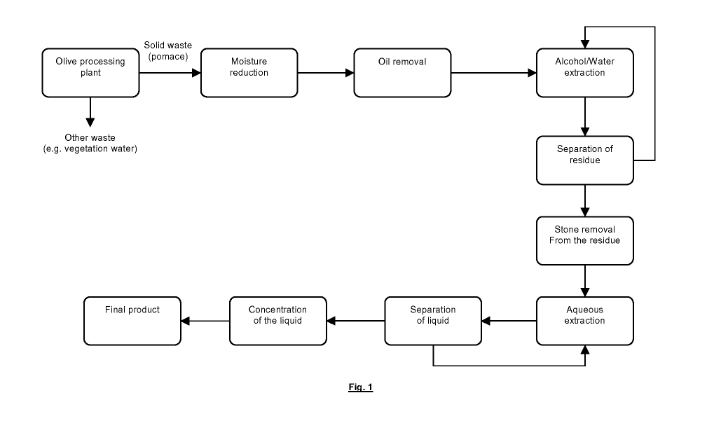

### CROSS REFERENCE TO RELATED APPLICATIONS

WO 2014018922 A1 claims rights to a protein isolate from soy processing by-products. The said invention is concerned with aqueous whey streams in the soy industry and the soy whey proteins isolated with emulsifying capabilities. The above invention is related to soy processing waste products, while the present invention pertains to olive processing waste, which is an entirely different material.

In the WO 2008082343 A1 world patent application, rights are claimed to pectin material isolated from olive mill wastewater. The above patent pertains to material reclaimed from the wastewater of olive processing, a totally different material than the solid waste that is related to the present patent. Furthermore, the material of the patent in question is not related to the reclaim of emulsifiers, which are the subject materials of the present p atent.

In U.S. Pat. No. 4,265,925 patent a method is described, in order to purify plant proteins from mixtures with carbohydrates and flavors. This method involves utilization of fluidized bed, inert gas treatment and an overall technology different from the one proposed herein. The end product of the invention is protein concentrate to be used as protein replacer in meat products, rather than emulsifiers/foaming agents for other applications.

U.S. Pat. No. 0146828 A1 “Development of a concentrated liquid of organic material from olive oil mill waste water; has high concentration of polyphenols normally found in the olive and has a high antioxidant capacity; fertilizer; food, cosmetic” pertains to the valorization of olive processing waste, including solid waste. It does not involve, however, the reclaim of materials of emulsification or foaming capacity. It is based on a series of decanting/centrifuge actions, rather than extraction, and claims the isolation of materials with antioxidant properties such as hydroxytyrosol, tyrosol, and oleuropein as high-added value products.

Patent WO 004331 A1 “Process for the industrial recovery of oleanolic and maslinic acids contained in the olive milling subproducts” describes an invention by which specific organic acids are reclaimed from olive milling by-products. These products are not proteins, polysaccharides or derivatives thereof; they are reclaimed by apolar solvents such as hexane, while the present invention involves extractions by means of polar, aqueous media.

A number of other patents involving the extraction of small -molecules (mostly phenolic) with antioxidant properties exist, for example U.S. Pat. No. 8,236,993 B2 “Process and apparatus for the production of hydroxytyrosol containing extract from olives and solids containing residues of olive oil extraction” which is based on the hydrolysis of the starting waste material, or WO 045514 A1 “Antioxidant compositions extracted from olives and olive by-products” which involves extraction of the starting material with a polar aqueous solvent to form an aqueous phase containing antioxidant components, then passing the aqueous phase through a solid matrix as to trap the antioxidant components on the matrix, and washing the matrix in question with a polar organic solvent to yield a solution of the antioxidant composition in the polar organic solvent. These methods are different processes in their conception from the present invention, while they result in obtaining different products.

| | | | Publication | Overview of differences |
|---|---|---|---|---|
| Pat. No. | Patent name | Filing date | date | from the present claims |
| WO2014018922A1 | Emulsifying agent for use in food | Jul. 26, | Jan. 30, | Related to soy products |
| | compositions | 2013 | 2014 | |
| WO2008082343A1 | Olive waste recovery | Feb. 28, | Jul. 10, | Reclaim from the |
| | | 2007 | 2008 | wastewater, rather from |
| | | | | the solid waste; different |
| | | | | products reclaimed. |
| U.S. Pat. No. 4,265,925 | Bland vegetable protein product and | Dec. 26, | May 5, | Technology and end |
| | method of manufacture | 1978 | 1981 | product different from the |
| | | | | ones described here. |
| U.S. Pat. No. 0,146,828A1 | Development of a concentrated liquid | Nov. 22, | Jun. 19, | Different process of |
| | of organic material from olive oil mill | 2005 | 2008 | isolation; different |
| | waste water; has high concentration of | | | materials claimed. |
| | polyphenols normally found in the | | | |
| | olive and has a high antioxidant | | | |
| | capacity; fertilizer; food, cosmetic | | | |
| WO004331A1 | Process for the industrial recovery of | Jul. 24, | Feb. 5, | Different process of |
| | oleanolic and maslinic acids contained | 1997 | 1998 | isolation; different |
| | in the olive milling subproducts | | | materials claimed. |
| U.S. Pat. No. 8,236,993B2 | Process and apparatus for the | Oct. 25, | Aug. 7, | Different process of |
| | production of hydroxytyrosol | 2008 | 2012 | isolation; different |
| | containing extract from olives and | | | materials claimed. |
| | solids containing residues of olive oil | | | |
| | extraction. | | | |
| WO045514A1 | Antioxidant compositions extracted | Oct. 15, | Jun. 28, | Different process of |
| | from olives and olive by-products | 2000 | 2001 | isolation; different |
| | | | | materials claimed. |

### Statement of Federally Sponsored Research or Development:

This Invention has been supported through the co-Financed by the European Union and the Greek State Program EPAN-II (OPC-II)/ ESPA (NSRF), SYNERGASIA 2011, project code 11SYN-1701-2.

### BACKGROUND OF THE INVENTION

A major need exists in the food, cosmetics and pharmaceutical industries for low-cost, natural emulsifiers.

Olive by-products are a major waste of olive-producing countries, the olive oil industry being among the most heavily polluting among the food industries (Arvanitoyannis, Kassaveti, & Stefanatos, 2007). The principal waste products of olive oil extraction and processing are vegetation water and a solid residue, comprising of the olive pulp, skin and stone (olive husk), and other components. Vegetation water attracted most of the attention concerning the recovery of potentially useful products (Vitolo Petarca, & Bresci. 1999; Papadimitriou, Maridakis, Sotiroudis, & Xenakis, 2005; Galanakis, Tornberg, & Gekas, 2010), mostly focused in reclaiming polyphenols and related antioxidant compounds (Visioli et al., 1999). Today, the main post-press treatment the solid residue undergoes is the solvent extraction of husk oil; this is typically followed by compression of the solid residue into briquettes which are to be used as fuel or as compost (Vitolo et al., 1999). Of interest remains the possibility of recovering food-grade materials of high added value such as emulsifiers and foaming agents from the solid olive waste.

During crushing and processing for olive oil extraction, the fruit cell walls rupture. The components of the olive paste comprise of two principal fractions, one soluble in successive elutions with aqueous buffers, and another being an insoluble residue containing protein, cellulose and other polysaccharides among its components. A wide range of composition and yields of olive extracts is reported; in a typical case the alcohol-insoluble yield being approximately 7-9%, while processed alcohol-insoluble fractions have been reported to contain between 30% and 50% polysaccharides and between 20% and 25% proteins (e.g. Huisman, Schols, & Voragen, 1996). The above suggest that compressed oil paste is a promising source of water-soluble macromolecules, containing, among other constituents, polysaccharides, proteins, glycoproteins, and products of their breakdown.

### REFERENCES

Arvanitoyannis, I. S., Kassaveti, A., & Stefanatos S. (2007) Current and potential uses of thermally treated olive oil waste International Journal of Food Science and Technology, 42, 852-867.

Galanakis, C. M., Tornberg, E., & Gekas, V. (2010) Clarification of high-added value products from olive mill wastewater, Journal of Food Engineering, 99,190-197.

Huisman, M. M. H., Schols, H. A., & Voragen, A. G. J. (1996) Changes in cell wall polysaccharides from ripening olive fruits, Carbohydrate Polymers, 31,123-133.

Papadimitriou, V., Maridakis, G. A., Sotiroudis, T. G., & Xenakis, A. (2005) Antioxidant activity of polar extracts from olive oil and olive mill wastewaters: an EPR and photometric study, European Journal of Lipid Science and Technology, 107,513-520.

Vitolo, S., Petarca, L., & Bresci, B. (1999) Treatment of olive oil industry wastes, Bioresource Technology, 67,129-137.

Visioli, F., Romani, A., Mulinacci, N., Zarini, S., Conte, D., Vincieri, F. F., & Galli, C. (1999) Antioxidant and other biological activities of olive mill waste waters, Journal of Agricultural and Food Chemistry, 47, 3397-3401.

### BRIEF SUMMARY OF THE INVENTION

This Invention includes: (i) a process to isolate a material from solid olive processing waste; (ii) the said material, which is able to act as an emulsifier for the formulation of oil-in-water emulsions.

### DESCRIPTION OF THE INVENTION

This Invention includes: (i) a process to isolate a material from solid olive processing waste; (ii) the said material, which is able to act as an emulsifier for the formulation of oil-in-water emulsions.

The process for the manufacture of the material in question is as follows:

Starting material of the present Invention is the solid waste obtained after crushing the olives and thus removing the olive oil, henceforth called olive pomace, also referred in various sources as olive husk, and olive mill cake. This material is subjected to moisture reduction. Moisture reduction of olive pomace can be achieved via a number of treatments, including but not being limited to drying under atmospheric pressure; drying under vacuum; freeze drying; or combinations of the above. Temperature in this stage should not exceed 70° C. Residual oil can be extracted by an appropriate process . This product of reduced oil content, that can be also the waste of olive husk oil production, is to be called exhausted olive mill husk.

Extraction of the exhausted olive mill husk using ethanol-water mixtures, of a composition ranging from 50% to 98% ethanol. After each extraction process, the solids are to be separated from the liquid. This can be achieved by a number of processes, including but not limited to, filtration; centrifugation; sedimentation; or combinations of the above. This extraction process under ethanol may be repeated from one to nine times. The resulting solid residue is of interest to this process.

Removal of the stone fragments by methods including but not limited to sieving and manual separation.

The stone-free material of the above treatment is subjected to aqueous extraction. The aqueous solvents used in this process may nonexclusively comprise of potable water; distilled water; de-ionized water; ultra-pure water; doubly or multiply distilled or de-ionized water; or combinations of the above. The pH of the aqueous solvent may be adjusted by the use of buffer solutions of indicative but not limiting concentrations ranging from 0 to 100 mM. These buffers include but are not limited to acetate and phosphate salts. The pH range of the extraction should range between pH 3 and pH 10. Extraction temperature can range between 50° C. and 80° C. This extraction step is to be followed by separation of the solid residues from the liquid medium. This can be achieved by a number of processes, including but not limited to, filtration; centrifugation; sedimentation; or combinations of the above. This extraction process may be repeated from one to five times. The material of interest to this Invention resides in the liquid phase.

The liquid phase produced by the previous stage undergoes processing as to reduce its water content to the desired level. Moisture reduction can be achieved via a number of treatments, including, but not being limited to, drying under atmospheric pres sure; rotary evaporation; drying under vacuum; freeze drying; spray drying; or combinations of the above. The final material (Olive Waste Emulsifier, OWE) is able to act as emulsifier for the production of oil-in-water emulsions. In its dry form, the material resulting from this process is a brittle, fabric-like sticky mass, odorless, almost tasteless, and yellow to brownish in color.

The material produced by means of the process described above (OWE) is able to act as an emulsifier for oil-in-water emulsions, that is, upon its dispersion or dissolution in an aqueous solution of an appropriate concentration, pH, temperature and salt content, and upon the subsequent addition of an appropriate amount of a hydrophobic liquid, including but not limited to vegetable oil, olive oil, melted fat, paraffin or hydrocarbon, or combinations of the above, and upon the enforcement of shear fields able to disrupt the oil into small droplets, it can conditionally contribute in providing stability against flocculation, aggregation, coalescence, phase inversion and Ostwald ripening.

The stability incurred by the application of OWE manifests as a stable distribution of the droplet sizes or a small increase of the average droplet size for a minimum of one day, as compared to the absence of an emulsifier, and within the statistical error of the measurement method. Typical applications include, but are not limited to: 1% w/v of the extract concentration to emulsify an oil-in-water emulsion of an oil volume fraction of 0.1, as to produce relatively fine droplets which can remain relatively stable for a period of at least 1 day.

This invention is effective at low concentrations as an emulsifier at pH values lying between pH 2 and pH 10. The exact range of effectiveness can be narrower or wider than this range, depending on the starting material, that is the condition and composition of the oil waste, and the choice of extraction media and process conditions. This product can conditionally be used as a stabilizer or emulsifier in food, cosmetics, and pharmaceutical applications. Under the above, potential applications may include but are not limited to, mayonnaise-type products, salad sauces, dressings, condiments, cocoa products, spreads, soups, day creams, desserts, spreads, beverages, dairy products, processed meat products, cured meat products, day creams, night creams, hand creams, body creams, emollient lotions, shampoos, bath formulations, drugs and relevant products.

What is claimed is:

1. A process for isolating emulsifiers capable of emulsifying oil-in-water emulsions from exhausted olive oil husk which is as following:
The exhausted olive mill husk is subjected to extraction by water-ethanol mixtures. The ethanol concentration can be from 50% to 98% w/w. The extraction takes place at 50° C.-80° C., for about an hour, under stirring. For every gram of exhausted olive oil husk processed, 100 to 500 mL of ethanol is used. The material is separated from the liquid phase as a residue. This solid material is dried for an indicative period of 1 h or more. This process can be repeated from one to nine times. Stones and stone fragments are removed from the material.
The stone-free material is extracted by an aqueous solvent. Extraction is performed at temperatures ranging from 20° C. to 90° C. and for times between ten minutes and twenty-four hours. The liquid phase is of interest to this Invention. This liquid phase is separated from the solid and is then concentrated to the desired moisture content. This process of extraction with fresh solvent, separation and moisture reduction can be repeated for up to five times, as to achieve a substantial yield of the product.

2. The end product according to claim 1 is the material of interest to this patent. The said material is comprised by a number of components, including but not limited to polysaccharides, proteins, and products of their hydrolysis.

3. The end product of claim 1 is characterized by its ability to act as emulsifier for use in oil-in-water emulsions.

4. The end product of claim 1 is characterized by its ability to act as stabilizer in complex emulsions.

5. The end product of claim 1 is characterized by its ability to act as emulsifier in complex emulsions.

6. The end product of claim 1 is characterized by its ability to act as emulsifier in complex colloidal products.

7. The end product of claim 1 is characterized by its ability to act as emulsifier for use in complex products containing emulsions.

8. The end product of claim 1 is characterized by its ability to act as emulsifier for use in emulsion-based complex products.

9. The end product of claim 1 is characterized by its ability to act as emulsifier for use in biologically-derived complex colloidal systems.
